(19) United States
(12) Patent Application Publication
(10) Pub. No.: US 2010/0313714 A1
(43) Pub. Date: Dec. 16, 2010

(54) FLOORING INSTALLATION TOOL AND METHOD

(76) Inventor: Ronnie D. Smith, Kansas City, KS (US)

Correspondence Address: LAW OFFICE OF MARK BROWN, LLC, 4700 BELLEVIEW SUITE 210, KANSAS CITY, MO, 64112, US

(21) Appl. No.: 12/482,812

(22) Filed: Jun. 11, 2009

(51) Int. Cl. B25D 1/16; B25B 27/02

(52) U.S. Cl. 81/27; 29/254; 254/133 R; 254/11

(57) ABSTRACT

A tool is provided for installing flooring with snap together edges. Specifically, the tool has a longitudinally-extending guide rod having a first impact member having a first impact face at a first end, and a second impact member having a second impact face at a second end. The first impact member has cleat extending below its lower surface adapted for engaging flooring edges. A sole is secured to the lower edge of the first impact member to protect the underlying flooring surface. The second impact member comprises a foot with an impact face. An impactor with first and second impact faces is slidably movable between the first impact member and second impact member for impacting the first and second impact faces respectively.

### BACKGROUND OF THE INVENTION

1. Field of the Invention

The present invention relates generally to flooring installation tools and procedures, and in particular to a tongue-and-groove flooring installation tool and method.

2. Description of the Related Art

In construction, floorings are made from various materials and assembled using different techniques and tools. Engineered flooring is attractive for both the customer and the installer. Customers are attracted to engineered flooring because it is a high quality, durable product that has versatile applications, and can come in a variety of colors, finishes, surface textures, and materials, such as plastic, laminate, wood, or tile. Floor installers appreciate engineered flooring because of the consistency of the manufactured product and ease by which the material can be installed.

Many engineered flooring products come in planks of varying dimensions that need to be fitted together to create the overall flooring application. Depending on the type of engineered flooring, the material is installed and secured in a variety of ways, such as nailing, stapling, gluing or floating. A floating floor is a fast and easy method of installing engineered flooring because the individual planks snap or slide together utilizing a tongue-and-groove engineering, and a limited number of tools are needed.

When assembling a floating floor, the installer mates opposing tongue-and-groove edges of the flooring material together by applying a force in the direction of the joint the installer is trying to close. The most common way of applying force to join engineered flooring is using a tapping block or pulling iron to abut the edge of flooring opposite the joint, and manually striking the object with a separate striking device such as a hammer or mallet to drive the planks together. A tapping block or pulling iron is used to prevent damaging the tongue-and-groove edge of the plank. A tapping block is abutted to the edge of the plank opposite the joint the installer is trying to close, and the back of the block is struck with a striking device, driving the planks together. Tapping blocks can be made from a variety of materials, such as wood, nylon, thermoplastic, or any other material that would not damage the edge of the plank. When there is not enough room to use a tapping block and swing a striking device, a pulling iron is substituted for the tapping block to join the planks. A pulling iron has a lip which abuts the edge of the plank and a striking surface that permits room for swinging the striking device.

A problem with using a tapping block, pulling iron, and striking device for installation of an engineered floor is that all of the tools are necessary for proper installation. Depending on the type of engineered flooring, the tongue-and-groove configuration can create the need for different sized tapping blocks with varying edges to prevent damage to the finished edge of the plank. Further, a pulling iron traverses the finished flooring requiring measures to be taken to prevent damage of the engineered flooring surface such as by placing a towel or cloth underneath the tool when it is in use. In addition, the striking device is often out of reach of the installer when he or she is preparing to join planks together, and when not in use, the striking device could damage the surface of the installed planks. The result is numerous tools are required to properly install engineered flooring without causing damage to the surfaces and edges of the planks, and time is wasted gathering the tools and using them properly.

Heretofore there has not been available a floor installation tool and method with the advantages and features of the present invention.

### BRIEF DESCRIPTION OF THE INVENTION

In the practice of the present invention, a flooring installation tool is provided which includes a cylinder slidably mounted on a guide shaft for striking movement between a block mounted on one end of the guide shaft and a foot mounted on the other end. The block includes a cleat, which hooks and engages the edges of floor planks being installed. The planks can be installed in various floor conditions, which can be accommodated by the installation tool.

### BRIEF DESCRIPTION OF THE DRAWINGS

The drawings constitute a part of this specification and include exemplary aspects of the present invention and illustrate various objects and features thereof.

FIG. 1 is an upper, front, side perspective view of a floor installation tool comprising an aspect of the present invention;

FIG. 2 is a side view thereof, showing flooring being installed;

FIG. 3 is a side view thereof, showing another flooring installation condition;

FIG. 4 is a side view thereof, showing yet another flooring installation condition;

FIG. 5 is a fragmentary, vertical cross-sectional view of a tongue-and-groove joint between first and second flooring planks; and

FIG. 6 is another fragmentary, vertical cross-sectional view of the tongue-and-groove joint, shown in an engaged configuration.

### DETAILED DESCRIPTION OF THE PREFERRED EMBODIMENT

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Aspect Flooring Installation Tool 2

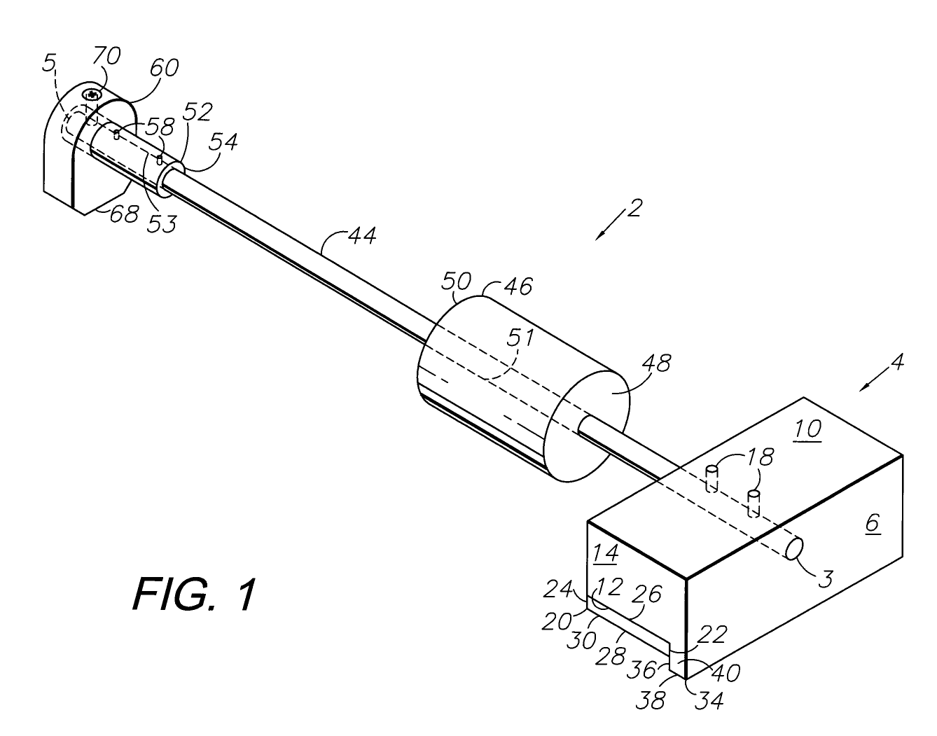

Referring to the drawings in more detail, the reference numeral 2 generally designates a flooring installation tool, as shown in FIGS. 1-4. Without limitation on the generality of useful applications of the present invention, the flooring installation tool 2 can be utilized for assembling an engineered flooring system 80 on a floor 72 by joining flooring planks, e.g., 75, 76 and 78.

The engineered flooring system 80 is comprised of a plurality of first flooring planks 75, second flooring planks 76 and third flooring planks 78 secured together by interlocking the groove profile 82 of a second flooring planks 76 with the tongue profile 82 of a third flooring planks 78. The first flooring plank 75, second flooring plank 76, and third flooring plank 78 can comprise a variety of materials, such as plastic laminate, wood, etc.

FIG. 1 shows the flooring installation tool 2, embodying the invention. The flooring installation tool 2 generally comprises a first impact member, such as a block 4, longitudinally connected to a second impact member, such as a collar 52 and a foot 60 by a guide shaft 44. An impactor, such as a cylinder 46, freely moves between the block 4 and collar 52 along the guide shaft 44. The block 4 has a sole 20 fixedly attached to the bottom block surface 12 by sole set screws 33 within the sole 20 and the block 4.

The block 4 is composed of a durable metal (e.g., hardened aluminum) and generally includes a front block surface 6, a back block surface 8, top block surface 10, bottom block surface 12, side block surfaces 14 and a cleat 34. The cleat 34 consists of a portion of the front block surface 6 that protrudes below the bottom sole surface 28, creating a bottom cleat surface 38 and a back cleat surface 36. The block 4 is fixedly secured to the front end of the guide shaft 44 by suitable mechanical fasteners, such as block set screws or pins 18 within the block 4.

The sole 20 is comprised of a suitable material that will not mar the surface of the engineered flooring system 80 (e.g. high molecular weight (HMW) plastic), and fits snugly against the bottom block surface 12 and the upper portion of the back cleat surface 36 along the top sole surface 26, and the front sole surface 22 respectively, thereby creating the back cleat surface 36. The sole 20 is fixedly secured to the bottom block surface 12 by sole set screws 33 within the sole 20 and the block 4. The side sole surface 30 is flush with the side block surface 14, and the back block surface 8 is flush with the back sole surface 24.

The cylinder 46 is comprised of a durable metal (e.g., steel) with a front cylinder surface 48, back cylinder surface 50, and center cylinder bore 51. The cylinder 46 has a length of, for example, approximately 2.5″ between the front cylinder surface 48 and back cylinder surface 50, and a diameter of, for example, approximately 2″. The center cylinder bore 51 is a diameter of, for example, approximately ⅜″ throughout extending the longitudinal length of the cylinder 46 from the center of the front cylinder surface 48 to the center of the back cylinder surface 50.

The guide shaft 44 consists of a first end 3 and second end 5, and is comprised of a durable metal (e.g., steel) with a length of, for example, approximately 15″, and a diameter of, for example, approximately ⅜″, and extends longitudinally from the interior of the block 4 at the first end 3 through the back block surface 8, through the center cylinder bore 51, through the front collar surface 54, terminating at the second end 5 within the collar 52. The guide shaft has a cross-sectional diameter less than the diameter of the center cylinder bore 51 allowing the cylinder 46 to freely move along the guide shaft 44.

The collar 52 is located at the second end 5 of the flooring installation tool 2, and is comprised of a durable metal (e.g., steel) with a length of, for example, approximately 2.5″, a cross-sectional diameter of, for example, approximately ¾″, and a center collar bore 53 greater than the diameter of the guide shaft 44. The collar 52 extends longitudinally through the foot 60. The collar 52 is fixedly secured to the second end 5 of the guide shaft 44 by suitable mechanical fasteners, such as collar set screws or pins 58 within the collar 52.

The foot 60 is located at the second end 5 of the flooring installation tool 2, and is comprised of a suitable material that will not mar the surface of the engineered flooring system 80 (e.g. plastic), with a thickness of, for example, approximately ¾″ thick. The foot 60 fits snug around the back end of the collar 52, fixedly secured to the second ends of the guide shaft 44, and the collar 52 by a foot set screw 70 within the foot 60, collar 52, and guide shaft 44.

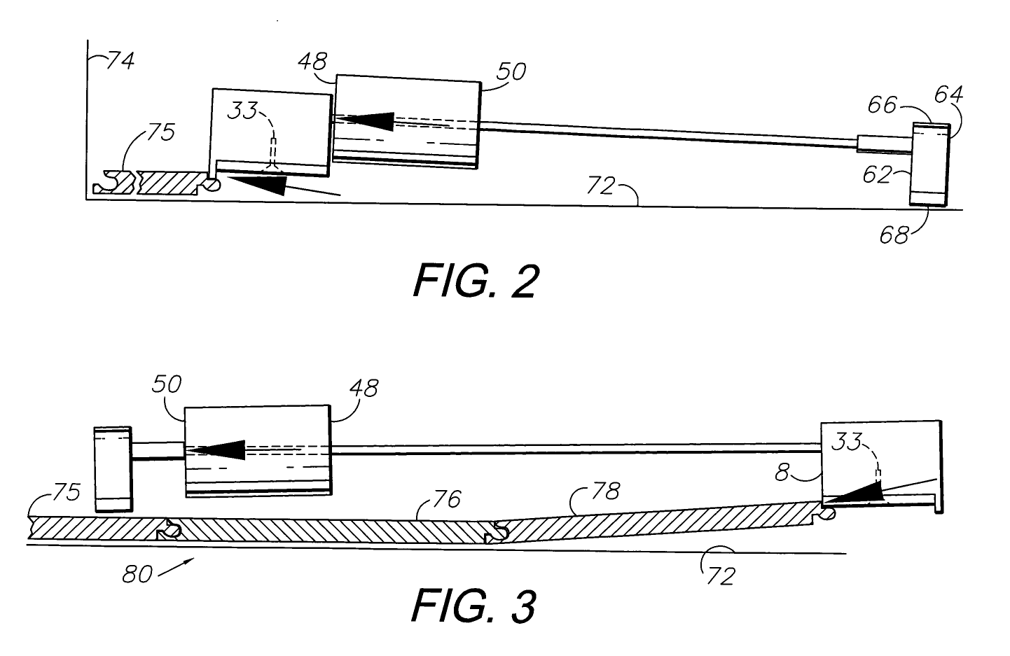

FIG. 2 shows an aspect of the flooring installation tool 2 as it is used to install a first flooring plank 75 when said plank abuts an obstacle such as a wall 74. The flooring installation tool 2 is positioned relative to the first flooring plank 75 whereby the bottom cleat surface 38 is placed on the top portion of a tongue profile 82 with the lower portion of the front block surface 6 in snug contact with the remaining edge of the first flooring plank 75. The bottom foot surface 68 rests upon the floor 72. The first flooring plank 75 is driven into place by sliding the cylinder 46 longitudinally along the guide shaft 44 from the second end 5 toward the first end 3 thereby bringing the front cylinder surface 48 in contact with the back block surface 8 with sufficient force to move the first flooring plank 75 into the desired alignment.

FIG. 3 shows an aspect of the flooring installation tool 2 as it is used to install a third flooring plank 78 into alignment with a second flooring plank 76 when there is no obstacle preventing positioning the foot 60 of the flooring installation tool on the installed portion of the engineered flooring system 80. The flooring installation tool 2 is positioned relative to the third flooring plank 78 whereby the back edge of the bottom sole surface 28 is placed on the top portion of a tongue profile 82 with the back sole surface 24 in snug contact with the remaining edge of the third flooring plank 78. The bottom foot surface 68 rests upon the installed portion of the engineered flooring system 80. The groove profile 84 of the third flooring plank 78 is driven into the tongue profile 82 of the second flooring plank 76 by sliding the cylinder 46 longitudinally along the guide shaft 44 from the first end 3 toward the second end 5 thereby bringing the back cylinder surface 50 in contact with the front collar surface 54 with sufficient force to move the third flooring plank 78 into the desired alignment with the second flooring plank 76.

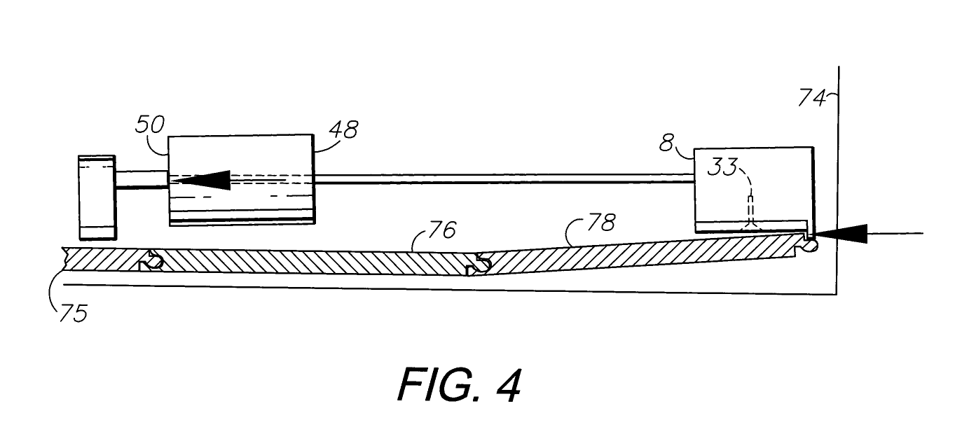

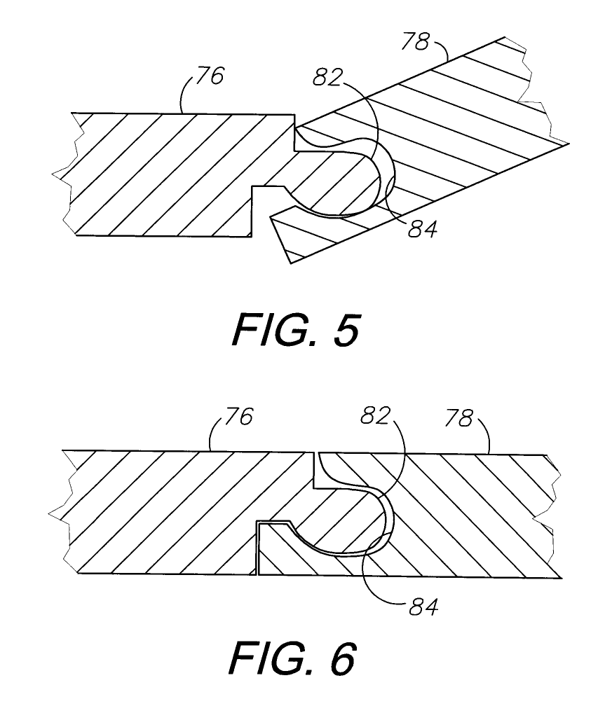

FIG. 4 shows an aspect of the flooring installation tool 2 as it is used to install a third flooring plank 78 when said plank abuts an obstacle such as a wall 74. The flooring installation tool 2 is positioned relative to the third flooring plank 78 whereby the bottom cleat surface 38 is placed on the top portion of a tongue profile 82 with the back cleat surface 36 in snug contact with the remaining edge of the third flooring plank 78. The bottom foot surface 68 rests upon the installed portion of the engineered flooring system 80. The groove profile 84 of the third flooring plank 78 is driven into the tongue profile 82 of the second flooring plank 76 by sliding the cylinder 46 longitudinally along the guide shaft 44 from the first end 3 toward the second end 5 thereby bringing the back cylinder surface 50 in contact with the front collar surface 54 with sufficient force to move the third flooring plank 78 into the desired alignment with the second flooring plank 76.

It will be appreciated that the components of the flooring installation tool 2 can be used for various other applications. Moreover, the flooring installation tool 2 can be fabricated in various sizes and from a wide range of suitable materials, using various manufacturing and fabrication techniques.

It is to be understood that while certain aspects of the invention have been shown and described, the invention is not limited thereto and encompasses various other embodiments and aspects.

Having thus described the invention, what is claimed as new and desired to be secured by Letters Patent is:

1. A double-throw impact tool for installing flooring with snap together edges, which tool includes:
a longitudinally-extending guide rod with first and second ends;
a first impact member mounted on said guide rod first end and including a front surface and an opposite impact face with said guide rod projecting therefrom;
said first impact member including a lower surface and a cleat depending downwardly from said lower surface and adapted for engaging said flooring edges;
a second impact member mounted on said guide rod second end and including a foot impact face with said guide rod projecting therefrom towards said first impact member;
an impactor with first and second impactor faces and a guide bore extending therebetween, said guide bore slidably receiving said guide rod; and
said impactor being slidably movable between a first impact position with said first impactor face impacting said first impact face and a second impact position with said second impactor face impacting said foot impact face.

2. The tool of claim 1, which includes:
said first impact member lower surface having a sole attached thereto;
said cleat comprising said impact member front surface, a bottom cleat surface, and a back cleat surface;
said back cleat surface having an upper edge in contact with said sole, and a lower edge depending therefrom.

3. The tool of claim 2, which includes:
said guide rod comprising a solid steel rod.

4. The tool of claim 2, which includes:
said first impact member comprising a hardened aluminum block.

5. The tool of claim 2, which includes:
said second impact member comprising a steel tube and a high molecular weight plastic foot, said foot extending below said steel tube.

6. The tool of claim 2, which includes:
said impactor comprising a steel cylinder.

7. The tool of claim 2, which includes:
said sole comprising high molecular weight plastic.

8. The tool of claim 2, which includes:
said first impact member adapted to receive pins for fixedly securing said first impact member to said guide rod;
said second impact member adapted to receive pins for fixedly securing said second impact member to said guide rod; and
said first impact member lower surface adapted to threadably receive a pair of screws for securing said sole to said first impact member.

9. A double-throw impact tool for installing flooring with snap together edges, which tool includes:
a longitudinally-extending steel guide rod with first and second ends;
a hardened aluminum block adapted to receive pins for fixedly securing said block to said guide rod first end, and said block including a front surface and an opposite impact face with said guide rod projecting therefrom;
said block including a lower surface and a cleat depending downwardly from said lower surface and adapted for engaging said flooring edges;
said cleat comprising said block front surface, a bottom cleat surface, and a back cleat surface;
said block lower surface adapted to threadably receive a pair of screws for securing a sole thereto;
said back cleat surface having an upper edge in contact with said sole, and a lower edge depending therefrom;
a steel tube adapted to receive pins for fixedly securing said tube to said guide rod second end, said tube including an impact face with said guide rod projecting thereform towards said block;
a steel cylinder with first and second impact faces and a guide bore extending therebetween, said guide bore slidably receiving said guide rod; and
said cylinder being slidably movable between a first impact position with said first impact face impacting said block impact face and a second impact position with said second impact face impacting said tube impact face.
